(19) United States
(12) Patent Application Publication
(10) Pub. No.: US 2020/0211570 A1
(43) Pub. Date: Jul. 2, 2020

(54) INTERACTIVE VOICE FRAUD DETECTION AND HANDLING

(71) Applicant: AT&T Intellectual Property I, L.P., Atlanta, GA (US)

(72) Inventors: Brian M. Novack, St. Louis, MO (US); Mark W. Smolensky, Robbinsville, NJ (US); Lynn Agnew, Plano, TX (US)

(21) Appl. No.: 16/236,010

(22) Filed: Dec. 28, 2018

(51) Int. Cl. G10L 17/22; G10L 17/00; G06K 9/00

(52) U.S. Cl. CPC G10L 17/22; G06K 9/00288; G10L 17/005

(57) ABSTRACT

Interactive voice fraud detection and handling is disclosed. A method can comprise receiving identifying data representing a social security number; verifying, based on the social security number, the identifying data relative to a record of records of a data store; and in response to determining, based on the social security number, the identifying data is not included in the record, requesting additional identifying data representing the social security number, wherein the additional identifying data comprises an idiosyncratic voice pattern associated with a user using the device

### TECHNICAL FIELD

The disclosed subject matter provides interactive voice recognition (IVR) systems and methods that, during interactions with a caller/user, through exchange of information, determines the caller/user is not a valid account holder and actionable malfeasance is being perpetrated.

### BACKGROUND

Currently, many activities and functions performed by human beings are being automated and are now performed by computer/processor-based automated voice-based facilities. Investigating and/or prosecuting telecommunication fraud to date, has been fraught with difficulties, e.g., when a caller/user calls a financial institution, such as a bank, using a telecommunications device, requesting details on their retirement investment accounts, there has not been a process to determine the bona fides of the caller/user. As a consequence, without being able to establish the bona fides of the caller/user, the financial institution is left vulnerable to potential multiple frauds perpetrated on the financial institution.

### BRIEF DESCRIPTION OF DRAWINGS

FIG. 1 is an illustration of a system for providing enhanced interactive fraud detection and handling, in accordance with aspects of the subject disclosure.

FIG. 2 is a further depiction of a system for providing enhanced interactive fraud detection and handling, in accordance with aspects of the subject disclosure.

FIG. 3 provides illustration of an additional system for providing enhanced interactive fraud detection and handling, in accordance with aspects of the subject disclosure.

FIG. 4 provides another illustration of a system for providing enhanced interactive fraud detection and handling, in accordance with aspects of the subject disclosure.

FIG. 5 illustrates another depiction of system for providing enhanced interactive fraud detection and handling, in accordance with aspects of the subject disclosure.

FIG. 6 depicts a further system for providing enhanced interactive fraud detection and handling, in accordance with aspects of the subject disclosure.

FIG. 7 provides illustration of a flow chart or method for providing enhanced interactive fraud detection and handling, in accordance with aspects of the subject disclosure.

FIG. 8 illustrates another flow chart or method for providing enhanced interactive fraud detection and handling, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein, like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate description of the subject disclosure.

The disclosed systems and methods, in accordance with various embodiments, provide a system, apparatus, or device comprising: a processor, and a memory that stores executable instructions that, when executed by the processor, facilitate performance of operations. The operations can comprise receiving identifying data, e.g. a social security number; verifying, based on the social security number, the identifying data relative to a record of records of a data store; and in response to determining, based on the social security number, the identifying data is not included in the record, soliciting additional identifying data representing the social security number, wherein the additional identifying data comprises a distinctive voice pattern associated with a user using the device.

Additional operations can comprise verifying the additional identifying data relative to the record of the records; where the record is a first database record, the operations further can comprise in response to determining that the additional identifying data is not included in the first database record, creating a second database record; storing the additional identifying data to a second database record; and obtaining, via a biometric device, biometric data as the additional identifying data, wherein the biometric data comprises voice recognition data representing a unique voice pattern of the user.

In accordance with further embodiments, the subject disclosure describes a method and/or process, comprising a series of acts that can include: based on obtaining first identifying data, verifying, by a system comprising a processor, the first identifying data with respect to a data store of records; based on the verifying, determining, by the system, the first identifying data is not represented in the data store of records; and based on the determining, obtaining, by the system, second identifying data representative of a distinctive voice cadence associated with a user using the system.

In accordance with the foregoing, the first identifying data can represent a social security number, the first identifying data can represent an individuated voice pattern associated with the user, the first identifying data can represent a license number of a registered driver, the first identifying data can represent an employee identification number, and/or the first identifying data can represent recognition data associated with facial recognition. Further, the second identifying data can represent a mail address of the user of the system, and/or the second identifying data can represent a name of the user of the system. As will be appreciated by those ordinarily skilled in the art, first identifying data (and/or the second identifying data) can be any data that can be used to identify a caller or user of the system. Thus, should the caller or user of the system inadvertently supply wrong first identifying data (or wrong second identifying data), the system can request that the caller or user of the system to re-enter the first identifying data (or the second identifying data). Additionally and/or alternatively, where the user or caller of the system supply wrong first identifying data (or wrong second identifying data), the system can prompt the caller or user of the system to respond to another query with additional identifying data (e.g., third identifying data).

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can include: in response to receiving initial identifying data, verifying the initial identifying data against a record of records; in response to the verifying, determining the initial identifying data is not represented in the record of records; and in response to determining, requesting additional identifying, data representing an idiosyncratic phraseology used by a user.

Additional operations can comprise soliciting or requesting, from the caller/user of the system, confirmation that the initial identifying data is correct; and determining the initial identifying data is not represented in the record of records as a function of executing a pattern matching process based on the initial identifying data.

In accordance with the foregoing, the record of records can comprise a database stored to a grouping of devices, and the additional identifying data can comprise mail data associated with the initial identifying data.

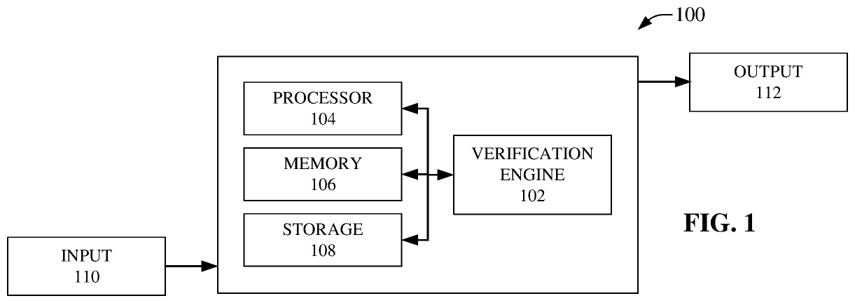

Now with reference to the Figures, FIG. 1 illustrates a system 100 for interactive fraud detection and handling. System 100 can include verification engine 102 that can be coupled to processor 104, memory 106, and storage 108. Verification engine 102 can be in communication with processor 104 facilitating operation of computer or machine executable instructions and/or components by verification engine 102, memory 106 for storing data and/or the computer or machine executable instructions and/or components, and storage 108 for providing longer term storage of data and/or machine and/or computer readable instructions. Additionally, system 100 can also receive input 110 for use, manipulation, and/or transformation by verification engine 102 to produce one or more useful, concrete, and tangible result, and/or transform one or more articles to different states or things. Further, system 100 can also generate and output the useful, concrete, and tangible results and/or the transformed one or more articles produced by verification engine 102 and output as output 112.

System 100, solely for purposes of elucidation, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing machines and/or databases, laptop computers, notebook computers, desktop computers, cell phones, smart phones, consumer appliances and/or instrumentation, industrial devices and/or components, hand-held devices, personal digital assistants, multimedia Internet enabled phones, multimedia players, and the like.

System 100 (e.g., verification engine 102) can receive (as input 110) data representative of an initiation request to initiate and establish a communication session between system 100 and a first device (e.g., a user equipment device, such as a telephone, cellular telephone, smart phone, . . . ). The initiation request can comprise data representative of information associated with caller/user information. Caller/user information can be representative of a social security number, user identification number, personal identification number (PIN), etc. Additionally and/or alternatively, caller/user information can also represent a unique originating identifier (caller/user's telephone number), quality of service (QoS) data, and the like. Further, in additional and/or alternative embodiments, caller/user information can also represent biometric information, such as voice pattern information/data, such voice pitch, speech cadence, timber, tone, iris scan data, finger print data, etc. of the caller/user.

Verification engine 102, in response to receiving caller/user information can determine whether or not the caller/user, based, for instance, on a social security number, a user identification number, personal identification number, employee identification number, iris scan data, finger print data, etc., is a good actor or a bad actor by communicating with a database device of a grouping of distributed databases devices that can store compilations of white lists and/or compilations of black lists that can each respectively represent persons that have previously perpetrated fraudulent activities and/or persons that have not perpetrated fraudulent activities. Verification engine 102, also in response to receiving caller/user information and/or based on data representing a unique originating identifier (e.g., a caller/user's telephone number), can determine from additional and/or alternative collections of networked database devices whether or not the caller/user is using a telecommunication device associated with a unique originating identifier that has been established as having been associated with fraudulent activity in the past.

Verification engine 102 upon determining, based for example on a social security number, a user identification number, a personal identification number, employee identification number, iris scan data, finger print data, and the like, and a correspondence identified in reference to a database device of a grouping of database devices that the caller/user is a possible bad actor, can confirm with the caller/user whether or not the social security number, user identification number, personal identification number, employee identification number, finger print data, iris scan data, or the like is correct. For instance, verification engine 102 can request the caller/user to reenter (e.g. where voice recognition software in execution is being used, restate the social security number, the user identification number, the personal identification number, employee identification number) or where a data entry device (e.g., associated with the calling device) is being utilized by the caller/user, verification engine 102 can request the caller/user to re-key or reenter the social security number, the user identification number, the personal identification number, the employee identification number, . . . using a keypad or a keyboard.

On substantiation by verification engine 102 that the social security number, the user identification number, the personal identification number, iris scan data, finger print data, or the employee identification number does not, for instance, match any social security number, user identification number, personal identification number, iris scan data, finger print data, or employee identification number that can have been persisted to a grouping of database devices, verification engine 102, on the basis the caller/user is a person intent on committing actionable malfeasance, can commence generating and presenting to the caller/user a series of questions to better identify the caller/user for purposes for investigation and possible legal prosecution.

In accordance with one or more embodiments, verification engine 102 can generate and request the caller/user to supply their first name and last name. Additionally, verification engine 102 can generate and request the caller/user to supply their date of birth. Further, verification engine 102 can request that the caller/user provide a mail address for additional material that verification engine 102 will be generating and mailing at a future date. Additionally and/or alternatively, verification engine 102 in one or more further embodiments, can request that the caller/user provide one or more identifying data elements regarding their mother's maiden name, their mother's date of birth, their father's place of birth, their father's date of birth, or the color, make, and model of the caller/user's first car. Verification engine 102, in accordance with various other embodiments, can request the caller/user to provide details regarding their current place of work, their previous place of work, the name of their spouse, etc.

In regard to the foregoing generating and requesting the caller/user to provide or supply further details, verification engine 102 can generate and select the queries randomly and/or based on a grouping or collections of pre-established pertinent questions that can have been stored to one or more database devices to which system 100 is in communication with, or that have been persisted to memory 106 and/or storage 108. Additionally and/or alternatively, verification engine 102 can used one or more machine learning, artificial intelligence, pattern recognition techniques to derive pertinent questions to request the caller/user to answer. For instance, verification engine 102 can use voice pattern recognition techniques to determine distinct regional differences in accent with respect to the caller/user. Further verification engine 102 can also use pattern recognition to identify distinct voice patterns or voice tics associated with the caller/user, such as emphasizing particular syllables or phrase combinations, etc. Additionally in one or embodiments, verification engine 102 can use machine learning techniques to identify distinct semantic phraseologies that can be used in different parts of the globe and that can better identify the caller/user and narrow down a geographic search scope for the location of the caller/user.

Once verification engine 102 has gathered sufficient identifying data with regard to the suspicious caller/user, such as the caller/user's first name and last name, mail address, and the like, verification engine 102 can notify the caller/user that further details and information will be mailed to them at the mail address supplied. Thereafter, verification engine 102 can escalate the issue to legal authorities for further investigation and prosecution, wherein all the information collected in regard to the suspicious caller/user can be stored to one or more investigatory law enforcement database devices.

In regard to the foregoing, it should be noted without limitation or loss of generality the functionalities and/or facilities provided system 100 can be implemented using avatars (e.g., a representation of an entity or an entity's alter ego or character) and/or bots (e.g., intelligent agents capable of autonomous action to achieve goals; intelligent agents generally can have the capabilities to acquire knowledge (learn) and apply the acquired knowledge to attain their goals).

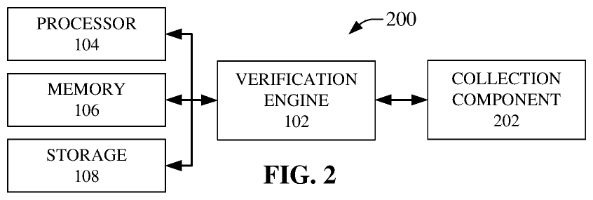

FIG. 2 illustrates system 100, now represented as system 200, that in accordance with various embodiments provides for interactive fraud detection and handling. In this depiction, system 200 can comprise verification engine 102 that can be communicatively coupled to processor 104, memory 106, and storage 108. Additionally, communicatively coupled to verification engine 102 can be collection component 202. Verification engine 102 in conjunction with collection component 202 can receive data representative of an initiation request to initiate and establish a communication session between a first device such as a user equipment device and system 200. Collection component 202 can receive data that represents information associated with a caller/user. Caller/user information can include data such as social security numbers, user identification numbers, personal identification numbers, employee identification numbers, and the like. Collection component 202 can also receive additional caller/user information such as a unique originating identifier, for instance, an international mobile subscriber identity (IMSI); a unique alpha numeric value that can be associated with the device being used by the caller/user to communicate with system 200. Additional caller/user information can comprise biometric information, such as voice pattern information/data that can include voice pitch, speech cadence, voice timber, voice tone and the like, associated with the caller/user. The information or data collected by collection component 202 can be persisted to one or more database device that can form a grouping of network devices. Additionally and/or alternatively and in accordance with various embodiments, the information and/or data collected via collection component 202 can be stored to memory 106 and/or storage 108.

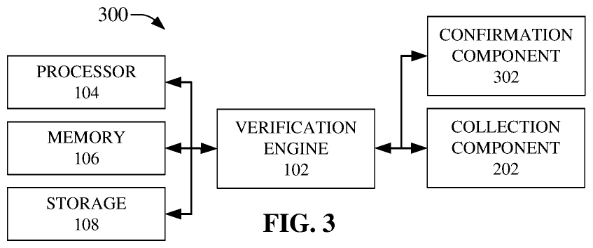

FIG. 3 provides additional illustration of system 100, now represented as system 300, that in accordance with various embodiments provides for interactive fraud detection and handling. As illustrated, system 300 can comprise collection component 202 operatively coupled to verification engine 102, processor 104, memory 106, and storage 108. Further, as illustrated system 300 can comprise confirmation component 302 that, in conjunction with collection component 202 and/or verification engine 102, and as a function of the data/information collected by collection component 202 can determine whether or not the caller/user, for instance, based on one or more of a social security number, a user identification number, a personal identification number, and/or an employee identification number, is a good actor or a bad actor. Confirmation component 302 can facilitate the foregoing functionality by communicating with one or more database device comprising a networked grouping or collection of distributed database devices. The grouping or collection of distributed database devices can store compilations of white lists and/or compilations of black lists. The white lists and/or the black lists can each respectively represent persons that have previously perpetrated fraudulent or felonious activities (e.g., black lists), and/or persons that have not previously perpetrated fraudulent activities and/or have not been involved in felonious and/or malicious activities (e.g., white lists).

Additionally and/or alternatively, in one or more various embodiments, confirmation component 302 can acquire from the caller/user additional data such as: an international mobile subscriber identity (IMSI), a temporary mobile subscriber identity (TMSI), and/or data obtained from a subscriber identification module (SIM) such as an integrated circuit card identifier (ICCID). Further additional data can comprise biometric data, for example, iris scan data, finger print data, voice data such a voice pattern data, voice cadence data, voice pitch data, voice tone data, and the like. The additional data can be used in collaboration with various database devices associated with aggregations of database devices to confirm and/or identify persons who have previously perpetrated fraudulent or felonious activities. It should be appreciated without limitation or loss of generality that the additional data can also be stored to one or more database device in conjunction with any and all data collected and/or collated by collection component 202.

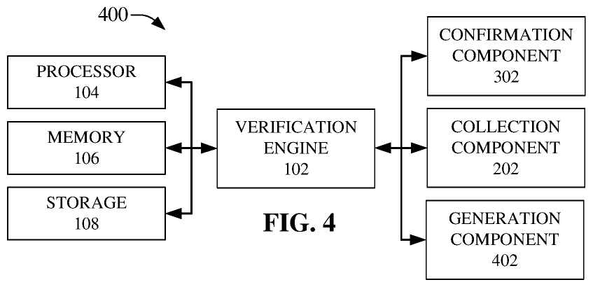

FIG. 4 provides additional depiction of system 100, now represented as system 400, that in accordance with various embodiments provides for enhanced interactive fraud detection and handling. In this instance, system 400 can comprise generation component 402 that can operate in collaboration with confirmation component 302, collection component 202, and verification engine 102. Generation component 402, based, for example, on a social security number, a user identification number, a personal identification number, and/or an employee identification number, and a correspondence identified in reference to a database device of the collection of database devices, can confirm that the caller/user is a possible bad actor, by requesting the caller/user to reenter, via a data entry device such as a keypad or keyboard, the social security number, the user identification number, the personal identification number, and/or the employee identification number, or where a voice recognition system is being used, restate the social security number, the user identification number, the personal identification number, and/or the employee identification number.

Generation component 402 can also request confirmation in regard to the additional data collected by confirmation component 302. For instance, generation component 402 can request the caller/user to state and/or repeat particular words, word sequences, and/or phrases. Such stating and repetition of words, word sequences, and/or phrases can be utilized to differentiate between one or more regional accent(s), identify idiosyncratic (e.g., unique or distinctive) voice pattern(s) individuated to the caller/user, and/or idiosyncratic voice cadence(s) particular to the caller/user.

Generation component 402, on substantiation, for instance, that the social security number, the user identification number, the personal identification number, and/or the employee identification number does not match with any social security number, user identification number, personal identification number, and/or employee identification number that can have been stored to a database device, generation component 402, based on the caller/user putatively having been identified as a bad actor, can generate and present to the caller/user a sequence of questions that could be utilized to better identify the caller/user for the purposes of future investigation and probable legal prosecution.

Generation component 402, in accordance with one or more various embodiments, can generate and request the caller/user to supply, for instance, their first name and last name. Further, generation component 402 can generate and request the caller/user to supply their date of birth. Generation component 402 can also request the caller/user provide a mail address so that system 100 can generate and/or mail literature at a future date. Generation component 402 can also request the caller/user provide one or more identifying data elements regarding their mother's maiden name, their mother's date of birth, their father's place of birth, their father's date of birth, or the color, make, model, of the caller/user's current automobile, the caller/user's current place of work, their previous place of work, the name of their spouse, and the like.

The generation and presentation of the queries to the caller/user can be produced by generation component 402 is a random manner (or pseudo-random manner, wherein, for example, one or more of the social security number, user identification number, personal identification number, or employee identification number can be used as a seed value) and/or based on collections of pre-establish pertinent questions that can have been stored to one or more database devices to which system 100 can be in communication with, and/or have been persisted to memory 106 and/or storage 108.

Generation component 402, as has been noted above, can use one or more machine learning, artificial intelligence, pattern recognition techniques to derive pertinent questions to request the caller/user to answer. For instance, generation component 402 can use pattern recognition techniques to determine regional differences in accents with respect to the caller/user, and based on the determination of a regional accent can generate and ask directed questions in regard to points of interest with respect to the identified region. Similarly, generation component 402 can use the unique originating identifier (e.g., the caller/user's telephone number) to generate and request answers to random questions/queries in relation to points of interest associated with the area code that can be included, for example, in the unique originating identifier.

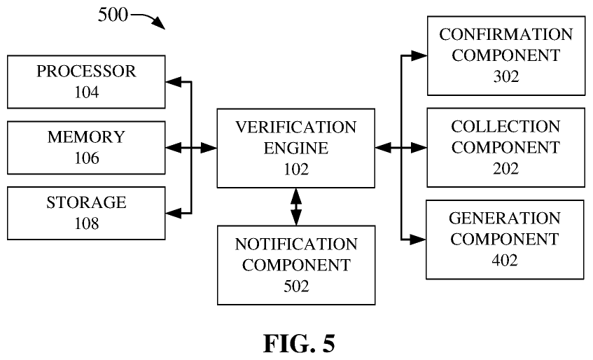

FIG. 5 provides further depiction of system 100, now represented as system 500, that in accordance with various embodiments provides for interactive fraud detection and handling. System 500 illustrates a notification component 502 that in conjunction with generation component 402, confirmation component 302, collection component 202, and verification engine 102, and based on system 500 having acquired at least a confirmed mail address with respect to the caller/user, can notify the caller/user that further details and information will be generated and forwarded to the confirmed mail address.

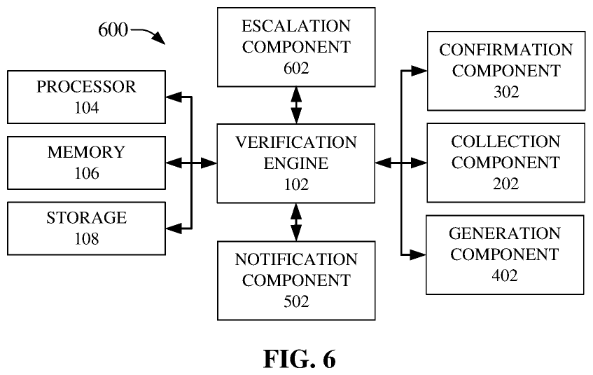

FIG. 6 provides yet further illustration of system 100, now represented as system 600, that in accordance with various embodiments provides for interactive fraud detection and handling. In regard to system 600, system 600 can comprise escalation component 602 that can operate in concert with notification component 502, generation component 402, confirmation component 302, collection component 202, and verification engine 102. In response to notification component 502 notifying the caller/user that further details and information is to be generated and forwarded to the confirmed mail address, escalation component 602 can forward the collected information (e.g., collected, confirmed, and/or collated by collection component 202, confirmation component 302, and generation component 402) to various investigative and/or legal entities for further investigation and/or legal prosecution. In accordance with various embodiments, escalation component 602 can access and store the collected information to one or more investigatory law enforcement database devices.

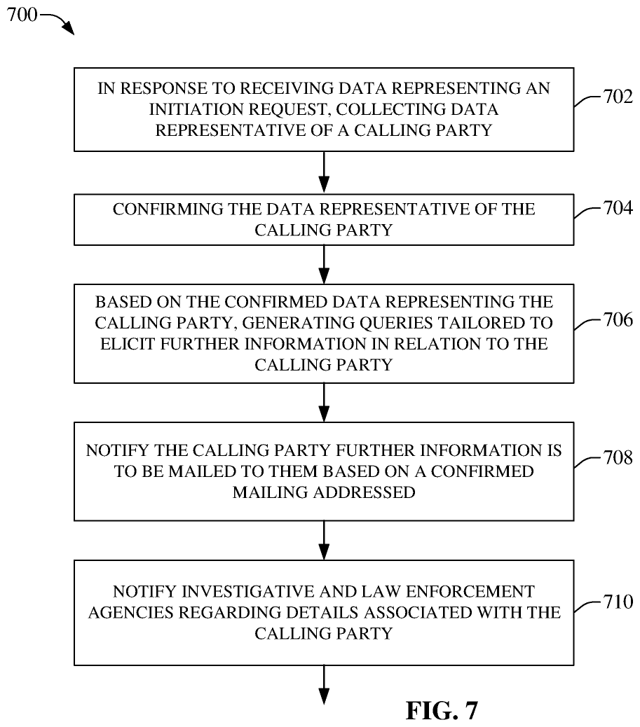

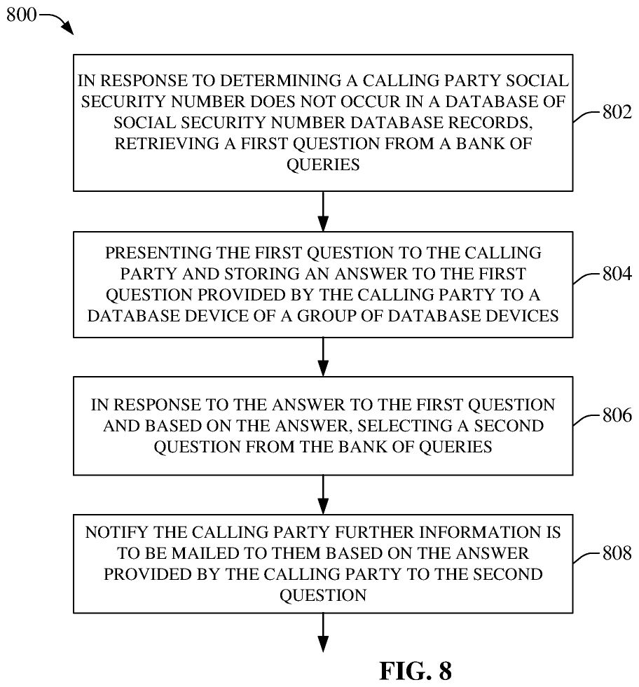

In view of the example system(s) described above, example method(s) that can be implemented in accordance with the disclosed subject matter can be better appreciated with reference to the flowcharts in FIGS. 7-8. For purposes of simplicity of explanation, the example method disclosed herein is presented and described as a series of acts; however, it is to be understood and appreciated that the disclosure is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, the disclosed example method can be implemented in combination with one or more other methods, to accomplish one or more aspects herein described. It should be further appreciated that the example method disclosed throughout the subject specification are capable of being stored on an article of manufacture (e.g., a computer-readable medium) to allow transporting and transferring such methods to computers for execution, and thus implementation, by a processor or for storage in a memory.

FIG. 7 illustrates a method 700 that provides for enhanced interactive fraud detection and handling. Method 700 can commence at act 702 wherein, system 100, in response to receiving data representing a communications initiation request from a user equipment device can commence collecting data representative of a caller/user. At 704, system 100 can confirm with the caller/user that the data representative of the caller/user supplied by the caller/user is true. At 706, based on the confirmed data representing the caller/user, system 100 can generate a series or sequence of queries tailored to elicit further pertinent information with regard to the caller/user. At 708, system 100 can notify the caller/user that additional information will be mailed to them based on a confirmed mail address the caller/user can have supplied in response to one or more of the series or sequence of queries. At 710, system 100 can notify investigative and law enforcement agencies regarding details associated with the caller/user. The investigative and law enforcement agencies can thereafter investigate whether a fraud has been committed and whether or not legal proceedings should be brought against the caller/user.

FIG. 8 illustrates an additional method 800 that provides for enhanced interactive fraud detection and handling. Method 800 can commence at act 802 wherein in response to determining that a caller/user social security number does not have an occurrence in a database of social security number database records, system 100 can retrieve a first question from a bank of queries. At 804, system 100 can present the first question to the caller/user and can store the answer to the first question provided by the caller/user to a database device of a group of database devices. At 806, in response to the answer to the first question and based on the answer provided by the caller/user to the first question, system 100 can select a second question from the bank of queries. At 808, system 100 can notify the caller/user that further information is to be mailed to them based at least on the answer to the second question.

It should be realized and appreciated by those of ordinary skill, the foregoing non-limiting example use application(s) are merely illustrations of a use to which the disclosed and described solution can be applied and thus are provided solely for the purposes of exposition. The described and disclosed subject matter is therefore not limited to the foregoing example application(s), but can find applicability in other more generalized circumstances and use applications.

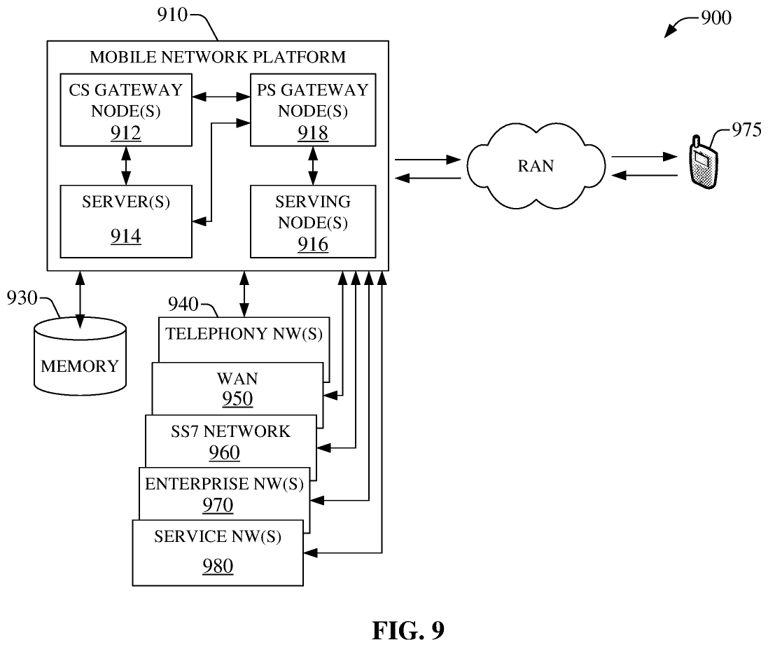

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 960; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 970 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload radio access network resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 970, or SS7 network 960. In aspect, memory 930 can be, for example, accessed as part of a data store component or as a remotely connected memory store.

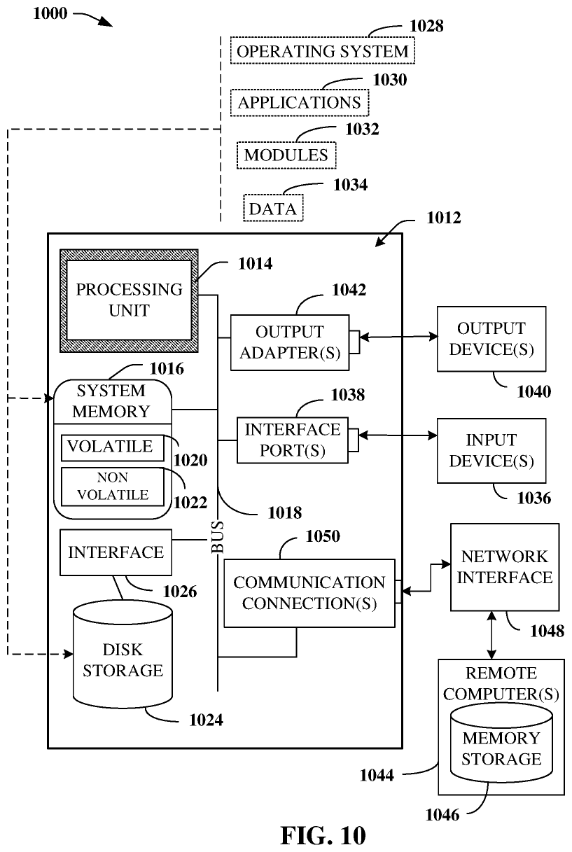

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of system 100, includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. For the avoidance of doubt, the term “computer-readable storage device” is used and defined herein to exclude transitory media. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (“RF”), infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile device and/or portable device can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine-readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
receiving identifying data;
verifying, based on the identifying data, the identifying data relative to a record of records of a data store; and
in response to determining, based on the identifying data, the identifying data is not included in the record, requesting additional identifying data, wherein the additional identifying data comprises a distinctive voice pattern associated with a user using the device.

2. The device of claim 1, wherein the identifying data comprises a social security number, a user identification number, a personal identification number, an employee identification number, iris scan data, or fingerprint data.

3. The device of claim 1, wherein the additional identifying data comprises a social security number, a user identification number, a personal identification number, an employee identification number, iris scan data, or fingerprint data.

4. The device of claim 1, wherein the operations further comprise verifying the additional identifying data relative to the record or records, wherein the record is a first database record, and wherein the operations further comprise in response to determining the additional identifying data is not included in the first database record, creating a second database record.

5. The device of claim 4, wherein the operations further comprise storing the additional identifying data to the second database record.

6. The device of claim 1, wherein the operations further comprise obtaining, via a biometric device, biometric data as the additional identifying data.

7. The device of claim 6, wherein the biometric data comprises voice recognition data representing the distinctive voice pattern of the user.

8. A method, comprising:
based on obtaining first identifying data, verifying, by a system comprising a processor, the first identifying data with respect to a data store of records;
based on a result of the verifying, determining, by the system, the first identifying data is not represented in the data store of records; and
based on the determining, obtaining, by the system, second identifying data representative of a unique voice cadence associated with a user using the system.

9. The method of claim 8, wherein the first identifying data represents a social security number.

10. The method of claim 8, wherein the first identifying data represents a distinctive voice pattern associated with the user.

11. The method of claim 8, wherein the first identifying data represents a license number of a registered driver.

12. The method of claim 8, wherein the first identifying data represents an employee identification number.

13. The method of claim 8, wherein the first identifying data represents recognition data associated with a facial recognition.

14. The method of claim 8, wherein the second identifying data represents a mail address of the user of the system.

15. The method of claim 8, wherein the second identifying data represents a name of the user of the system.

16. A machine-readable storage medium, comprising executable instructions that, when executed by a processor, facilitate performance of operations, comprising:
in response to receiving initial identifying data, verifying the initial identifying data against a record of records;
based on the verifying, determining the initial identifying data is not represented in the record of records; and
in response to the determining, requesting additional identifying data representing an idiosyncratic phraseology used by a user.

17. The machine-readable storage medium of claim 16, wherein the operations further comprise soliciting, from user input of the user, confirmation that the initial identifying data is correct.

18. The machine-readable storage medium of claim 16, wherein the record of records comprises a database stored to a grouping of devices.

19. The machine-readable storage medium of claim 16, wherein the additional identifying data comprises mailing data associated with the initial identifying data.

20. The machine-readable storage medium of claim 16, wherein the operations further comprise determining the initial identifying data is not represented in the record of records as a function of executing a pattern matching process based on the initial identifying data.
